(19) United States
(12) Patent Application Publication
(10) Pub. No.: US 2005/0048984 A1
(43) Pub. Date: Mar. 3, 2005

(54) System and method for group restricted access of a shared access controller

(76) Inventors: Neal C. Foster, Manalapan, NJ (US); Alan P. Salzman, Morristown, NJ (US); Matthew G. Samonek, Southlake, TX (US)

Correspondence Address: MOTOROLA INC, 600 NORTH US HIGHWAY 45, ROOM AS437, LIBERTYVILLE, IL, 60048-5343, US

(21) Appl. No.: 10/449,433

(22) Filed: May 30, 2003

(51) Int. Cl. H04Q 7/20

(52) U.S. Cl. 455/453; 455/560; 455/433

(57) ABSTRACT

There is provided a shared access controller (104) of a wireless communication system (100) for providing restricted access of network resources to mobile stations (106). The controller (104) includes an interface (306) configured to receive a request for access to any available network resource from a mobile station (106) of a tier, and a processor (302) configured to reject the request in response to determining that a current number of network resources accessed by the mobile stations of the tier would exceed a tier number of network resources permitted to be accessed by mobile stations of the tier. Likewise, the mobile station (106) includes a transceiver (206) configured to transmit a request for access to any available network resource and to receive a response to the request based on the above determination by the controller.

### FIELD OF THE INVENTION

The present invention relates generally to the field of channel access for wireless communication systems. In particular, the present invention relates to shared access controllers that provide tiered access privileges to associated mobile stations based on subscriber groupings.

### BACKGROUND OF THE INVENTION

Wireless communication systems are generally provided by various service providers. Many wireless communication systems provide each user with unrestricted access to communication within one or more defined geographic areas. For example, users are provided with any available access to a service provider's network within a user's local area, and the provided services are generally only limited by the maximum capacity of the network.

In providing the services of a wireless communication system to users, the service providers incur substantial costs in installing the communication network and continue to incur substantial costs in maintaining the communication network, such as the cost of using call management and billing software. Equipment manufacturers and service providers of the wireless communication industry are focused on reducing these installation and operational costs directly. Many service providers continue to provide each user with unrestricted access to communication within one or more defined geographic areas.

Some wireless communication systems are capable of providing varying priority treatment of subscribers differentiated by tiered groups. For example, the Japan TZ802 system and the Global System for Mobile Communications (“GSM”) have provisions for providing different priority service for different groups of subscribers. For such systems, a high priority group would have access to traffic channels reserved for that group, and a low priority group would not have access to these reserved traffic channels. Unfortunately, by barring a tier from accessing certain traffic channels, efficient use of the traffic channels is compromised.

Accordingly, there is need for a wireless communication system that minimizes the operational costs of a wireless communication system and maximizes efficient use of the system while maintaining a user acceptable level of communication service. It is further desirable to reduce the operational costs of a wireless communication system without incurring substantial installation costs.

### BRIEF DESCRIPTION OF THE DRAWINGS

FIG. 1 is a system view of a network model in accordance with the present invention.

FIG. 2 is a block diagram representing an exemplary mobile station of FIG. 1.

FIG. 3 is a block diagram representing an exemplary controller of FIG. 1.

FIG. 4 is a flow diagram representing an exemplary logic flow of a controller of FIG. 1.

FIG. 5 is a message sequence chart representing a mobile originated call in accordance with the present invention.

FIG. 6 is a message sequence chart representing a mobile terminated call in accordance with the present invention.

FIG. 7 is a message sequence chart representing a peer released call in accordance with the present invention.

### DETAILED DESCRIPTION OF THE PREFERRED EMBODIMENTS

The present invention is directed to a system and method for minimizing the operation costs of a wireless communication system by providing an efficient service offering that provides a subscriber acceptable level of communication service. Although the system and method may be an integral part of a newly-constructed network, the system and method may also be installed and implemented at minimal costs by adapting to existing infrastructure.

One aspect of the present invention is a shared access controller, and a method thereof, for providing restricted access of network resources to mobile stations comprising an interface and a processor coupled to the interface. The interface is configured to receive a request for access to any available network resource from a mobile station of a tier. The processor is configured to reject the request in response to determining that a current number of network resources accessed by the mobile stations of the tier would exceed a tier number of network resources permitted to be accessed by mobile stations of the tier. For the method, the shared access controller receives a request for access to any available network resource from a mobile station of a tier. The shared access controller then determines whether a current number of network resources accessed by the mobile stations of the tier would exceed a tier number of network resources permitted to be accessed by mobile stations of the tier. Thereafter, the shared access controller rejects the request for access in response to determining that the current number of network resources would exceed the tier number of network resources.

Another aspect of the present invention is a mobile station, and a method thereof, for receiving restricted access of network resources of a wireless communication system comprising a transceiver configured to transmit a request for access to any available network resource. The transceiver is also configured to receive a response to the request based on whether a current number of network resources accessed by the mobile stations of the tier would exceed a tier number of network resources permitted to be accessed by mobile stations of the tier. For the method, the mobile station transmits a request for access to any available network resource. The mobile station then receives a response to the request based on whether a current number of network resources accessed by the mobile stations of the tier would exceed a tier number of network resources permitted to be accessed by mobile stations of the tier.

Yet another aspect of the present invention is a wireless communication system for providing restricted access of network resources to certain mobile stations comprising first and second groups of mobile stations. The first group of mobile stations is capable of accessing a plurality of network resources. The second group of mobile stations is capable of accessing the plurality of network resources only if, at any given time, a current number of network resources accessed by the second group of mobile stations does not exceed a tier number of network resources permitted to be accessed by the second group of mobile stations.

Although the embodiments disclosed herein are particularly well suited for use with a cellular telephone, persons of ordinary skill in the art will readily appreciate that the teachings of this disclosure are in no way limited to cellular telephones. On the contrary, persons of ordinary skill in the art will readily appreciate that the teachings of this disclosure can be employed with any wireless communication device such as a paging device, a personal digital assistant (“PDA”), a laptop computer, a notebook computer, a subnotebook computer, a handheld computer, and the like.

The wireless communication system in accordance with the present invention is described in terms of several preferred embodiments, and particularly, in terms of a wireless communication system operating in accordance with at least one of several standards. These standards include analog, digital or dual-mode communication system protocols such as, but not limited to, the Advanced Mobile Phone System (“AMPS”), the Narrowband Advanced Mobile Phone System (“NAMPS”), the Global System for Mobile Communications (“GSM”), the IS-55 Time Division Multiple Access (“TDMA”) digital cellular system, the IS-95 Code Division Multiple Access (“CDMA”) digital cellular system, CDMA 2000, the Personal Communications System (“PCS”), 3G, the Universal Mobile Telecommunications System (“UMTS”), and variations and evolutions of these protocols. The wireless communication system in accordance with the present invention may also operate via an ad hoc network and, thus, provide point-to-point communication with the need for intervening infrastructure. Examples of the communication protocols used by the ad hoc networks include, but are not limited to, IEEE 802.11a, IEEE 802.11b, IEEE 802.11g, Bluetooth, and infrared technologies.

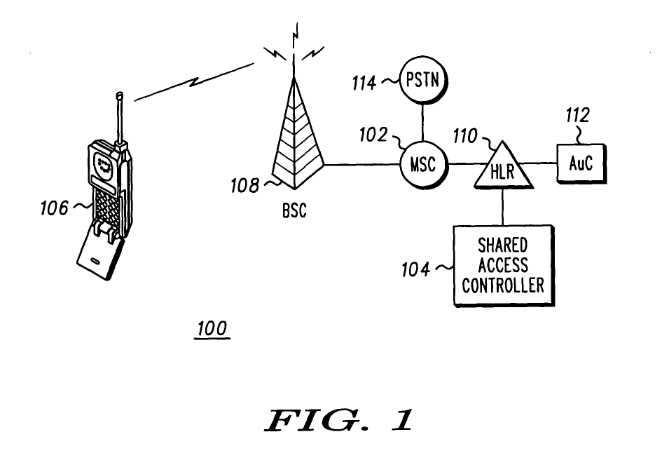

Referring to FIG. 1, a wireless communication system 100 in accordance with the present invention includes a plurality of mobile stations communicating with a network infrastructure. The network infrastructure includes at least one Mobile Switching Center (“MSC”) 102 and at least one shared access controller 104 shown in FIG. 1. For the preferred embodiment, the wireless communication system 100 includes a plurality of mobile stations 106 and at least one shared access controller 104 as described herein, but may communicate with each other over any type of air interface and network elements that are generally used for voice and data communications.

The network infrastructure will be configured such that the plurality of mobile station 106, and/or their associated subscribers, are grouped in two or more tiers of service. For each tier, a predetermined number of network resources is reserved for use by the mobile stations and/or subscribers, and the number of network resources for each tier is under the control of, or at least supervised by, the shared access controller 104. For at least one tier, the mobile stations of the tier are capable of accessing more network resources than the predetermined number of network resources permitted to be accessed by them. For example, a group of mobile stations of a particular tier may be capable of accessing all channels of the network infrastructure, but only a certain number of mobile stations of the particular tier may access the channels at any given time. If the maximum number of channels permitted from the tier has been reached, the next mobile station attempting to use the network infrastructure may only access a channel after a currently used channel is released by another mobile station of the tier. It should be noted that, if a currently used channel is released by another mobile station of the tier, the next mobile station may use any available channel and is not restricted to the channel that has just been released. The ratio of subscribers to number of resources, i.e., channels, may be configured to address specific usage patterns. The service may be configured by a network operator or any other entity having an interest in the wireless communication system 100.

Typically, the network infrastructure of the wireless communication system 100 also includes at least one base station controller (“BSC”) 108, at least one Home Location Register (“HLR”) 110, and at least one Authentication Center (“AuC”) 112. The MSC 102 is the hub of the communication system and, primarily, controls calls to and from other telephone and data systems, such as for example a Public Switched Telephone Network (“PSTN”) 114. The MSC 102 provides all the necessary functionality involved in registering, authenticating, location updating, and call routing for a subscriber. The HLR 110 is a database that includes subscriber information, such as the operation data about the subscriber's mobile station. The AuC 112 determines whether to validate each subscriber logging-on to the communication system. If the AuC 112 validates a subscriber, then the subscriber is allowed access to the network infrastructure.

As described in detail below, the shared access controller 104 is part of the network infrastructure and, thus, may be connected to a wireless network. The shared access controller 104 may serve as an HLR 110 and AuC 112 for the mobile stations 106. Thus, for full functionality within the present service for aggregating network resources, the mobile stations 106 communicate and otherwise operate via the shared access controller 104.

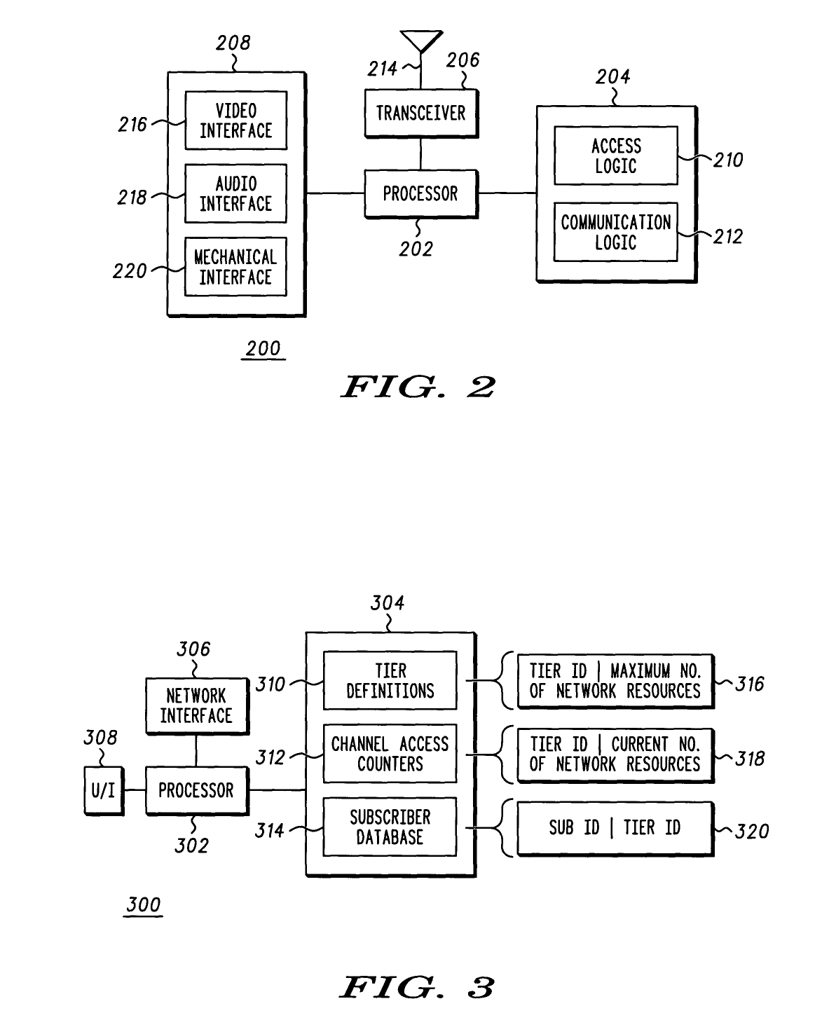

FIG. 2 shows various exemplary components that may be utilized by each mobile station 106 of the communication system 100. Each mobile station 106 may include a processor 202 and a memory 204, a transceiver 206, and a user interface 208 that are coupled together for operation of the respective mobile station. It is to be understood that two or more of these internal components 200 may be integrated within a single package, or functions of each internal component may be distributed among multiple packages, without adversely affecting the operation of each mobile station 106.

As stated above, each mobile station 106 includes the processor 202 and the memory 204. The processor 202 controls the general operation of the mobile station 106 including, but not limited to, processing and generating data for each of the other internal components 200. The memory 204 may include access logic 210, and/or communication logic 212. Each of the access logic 210 and the communication logic 212 may include one or more sets of the operating instructions that may be embodied in a computer-readable medium such as, but not limited to, paper, a programmable gate array, flash memory, application specific integrated circuit (“ASIC”), erasable programmable read only memory (“EPROM”), read only memory (“ROM”), random access memory (“RAM”), magnetic media, and optical media. The access logic 210, such as a client application, communicates the necessary information with the shared access controller 104 for access to network resources of the network infrastructure. The communication logic 212, such as a modem, provides the necessary instructions for proper communication with the network infrastructure via the transceiver 206.

Each mobile station 106 also includes the transceiver 206, which provides communication capabilities with other entities, such as the BSC 108 and/or other mobile stations 106. For the preferred embodiment, the transceiver 206 operates through an antenna 214 in accordance with at least one of several standards including analog, digital or dual-mode communication system protocols and, thus, communicates with appropriate infrastructure. However, as referenced above, the transceiver 206 may also provide point-to-point communication via an ad hoc network.

Each mobile station 106 also includes the user interface 208. The user interface 208 may include a video interface 216, an audio interface 218 and/or a mechanical interface 220. Examples of the video interface 216 include displays and cameras, examples of the audio interface 218 include speakers and microphones, and examples of the mechanical interface 220 include keypads, touch pads, touch screens, selection buttons, vibrating mechanisms, and contact sensors.

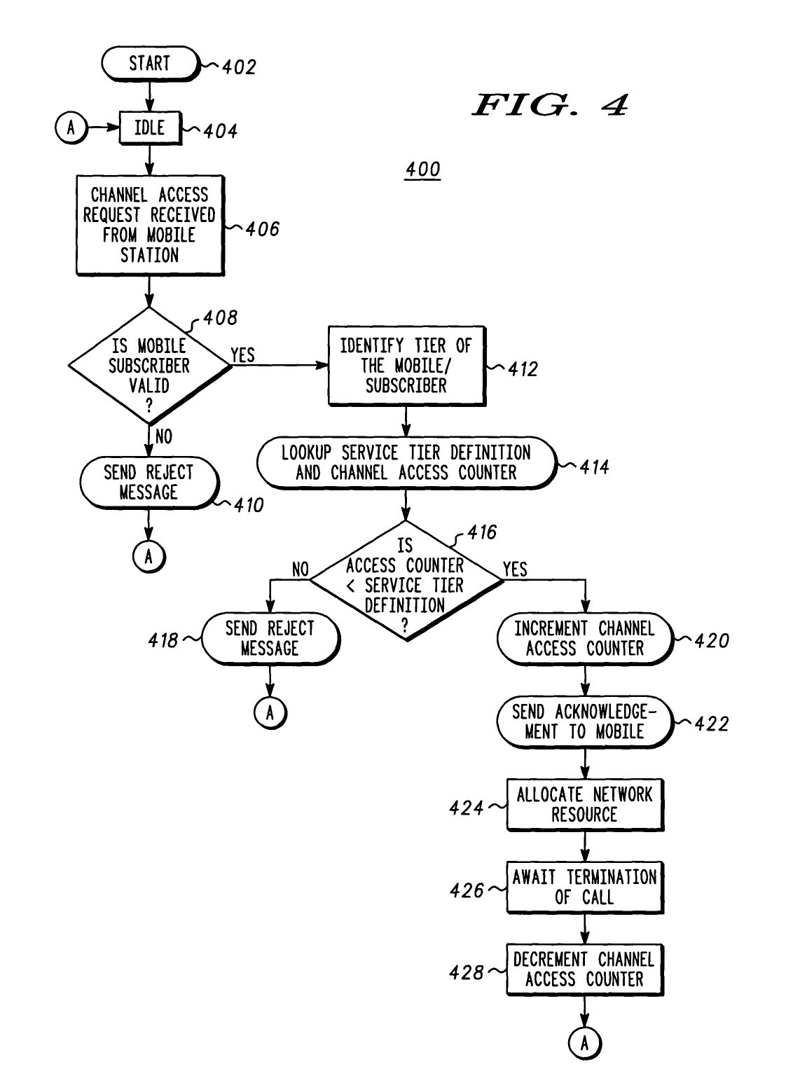

Referring to FIG. 3, the shared access controller 104 communicates with, or is part of, the network infrastructure and includes various internal components 300. It is to be understood that mobile stations 106 may communicate with the shared access controller 104 through the network infrastructure, directly or through another device. The shared access controller 104 includes a processor 302 and a memory 304, and a network interface 306 that are coupled together for operation of the server. Optionally, the shared access controller 104 may also include a user interface 308 for interactive input and output of information with a user when installing, operating and/or maintaining the server. It is to be understood that two or more of these internal components 300 may be integrated within a single package, or functions of each internal component may be distributed among multiple packages, without adversely affecting the operation of the shared access controller 104.

As stated above, the shared access controller 104 includes the processor 302 and the memory 304. The processor 302 controls the general operation of the shared access controller 104 including, but not limited to, processing and generating data for each of the other internal components 300. The memory 304 may include tier definitions 310, network resource access counters 312 (hereinafter channel access counters) 312 and subscriber data 314. Each portion of the memory 304 may include one or more sets of the operating instructions that may be embodied in a computer-readable medium such as, but not limited to, paper, a programmable gate array, flash memory, ASIC, EPROM, ROM, RAM, magnetic media, and optical media.

The tier definitions 310 of the memory 304 include, but are not limited to, configuration information for each tier of mobile stations of the wireless communication system 100. In particular, the tier definitions 310 identifies a maximum number of network resources, corresponding to a maximum number of network resources that may be used or accessed by mobile stations for each tier at any given time. Accordingly, each tier definition 316 may include a tier identification field and a maximum number of network resources field associated with the tier identification field.

The network resource access counters 312, i.e., channel access counters, of the memory 304 include, but are not limited to, tracking information for each tier of mobile stations of the wireless communication system 100. In particular, the channel access counters 312 identifies a current number of network resources, corresponding to current number of network resources in use or being accessed by the mobile stations of each tier. Accordingly, each channel access counter 318 may include a tier identification field and a current number of network resources field associated with the tier identification field.

The subscriber database 314 of the memory 304 include, but are not limited to, collected information for mobile stations 106 and/or subscribers utilizing the wireless communication system 100. In particular, the subscriber database 314 identifies a subscribed tier for each mobile station and/or subscriber utilizing the wireless communication system 100. In the alternative, the subscriber database 314 may assign a default tier to any subscriber that is not associated with a particular tier. Each subscriber record of the subscriber database 314 may include a mobile station identification field and/or a subscriber identification field as well as a tier identification associated with the mobile station identification field and/or the subscriber identification field.

Referring to FIG. 4, there is provided a flow diagram representing an exemplary logic flow of the shared access controller 104. Beginning at step 402, the shared access controller 104 exchanges information with a mobile station 106 and determines that the mobile station has powered-up and is in idle mode at step 404. During idle mode, the mobile station 106 is not communicating with another device through the network infrastructure and, thus, does not require a network resource. At some time thereafter, the shared access controller 104 receives a network resource access request or channel access request from the mobile station 106 at step 406. The network resource access request includes, but is not limited to, a mobile station identification and/or a subscriber identification. The shared access controller 104 then determines whether the mobile station 106 is a valid device for operation via the network infrastructure at step 408. In the alternative, the shared access controller 104 may determine whether the subscriber associated with the mobile station 106 is a valid user subscribing to usage of the network infrastructure. If the mobile station 106 and/or the subscriber are not valid, then the shared access controller 104 sends a rejection message to the mobile station at step 410 and awaits another request from the mobile station at step 406.

If the mobile station 106 and/or the subscriber are valid, then the shared access controller 104 identifies the tier identification corresponding to the mobile station identification and/or subscriber identification by reviewing the subscriber database 314 at step 412. Next, the shared access controller 104 identifies the maximum number of network resources and current number of network resources corresponding to the tier identification by reviewing the tier definitions 310 and channel access counters 312 at step 414. The shared access controller 104 then determines whether a current number of network resources accessed by the mobile stations of the tier, i.e., current number of network resources, would exceed a tier number of network resources permitted to be accessed by mobile stations of the tier, i.e., maximum number of network resources, if a network resource is allocated to the mobile station 106 currently requesting access at step 416. If not, then the shared access controller 104 sends a rejection message to the mobile station 106 at step 418 and await another request from the mobile station at step 406. Otherwise, the shared access controller 104 increments the channel access counter or, more particularly, the current number of network resources corresponding to the tier of the mobile station 106 at step 420, sends an acknowledgment message to the mobile station at step 422, and allocates a network resource to the mobile station at step 424.

After a network resource has been allocated to the mobile station 106 so that the mobile station may complete a call via the network infrastructure, the shared access controller 104 awaits a signal from the mobile station and/or MSC 102 indicated that the call has been terminated at step 426. After the signal indicating termination of the call has been received, the shared access controller 104 decrements the channel access counter or, more particularly, the current number of network resources corresponding to the tier of the mobile station 106 at step 428. Thereafter, the shared access controller 104 awaits another request from the mobile station 106 at step 406.

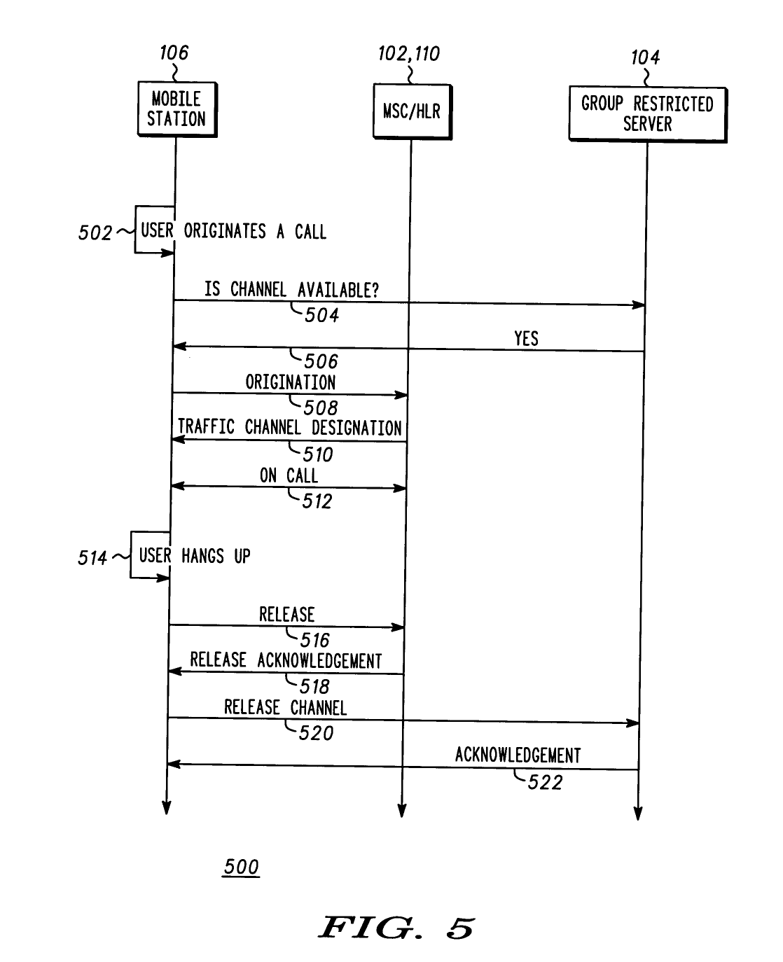

Referring to FIG. 5, there is provided a message sequence chart representing a preferred procedure 500 for a mobile originated call. As shown in FIG. 5, the mobile station 106, the Mobile Switching Center and/or Home Location Register (“HLR/MSC”) 102,110, and the shared access controller 104 are the primary entities to provide restricted access of network resources in accordance with the present invention. However, other components including, but not limited to, the base station controller (“BSC”) 108, the Authentication Center (“AuC”) 112, and the Public Switched Telephone Network (“PSTN”) 114 may also provide supplemental functionality for restricted access of network resources.

For the mobile originated call, the mobile station 106 originates a call at step 502. In particular, the communication logic 212 of the mobile station initiates a call via the transceiver 206 in response to receiving input from the user interface 208. The mobile station 106, in response to initiating the call, transmits a network resource request, e.g., a channel request, to the shared access controller 104 at step 504. As described above in reference to FIG. 4, the shared access controller 104 performs various several steps before returning a response to the network resource request to the mobile station 106 at step 506. If the response to the network resource request is negative, then the call is not connected. If, on the other hand, the response is affirmative (as shown in FIG. 5), then the mobile station 106 transmits an origination signal to the MSC/HLR 102, 110 at step 508 after the affirmative response is received. Next, the MSC/HLR 102, 110 allocates a traffic network resource to the mobile station 106 and returns a traffic network resource designation signal identifying the traffic network resource to the mobile station at step 510. Thereafter, the call is completed and the mobile station 106 communicates with a remote device via the MSC/HLR 102, 110 at step 512.

A call may be terminated by the mobile station 106 and/or the remote device communicating with the mobile station. For the situation where the mobile station 106 terminates the call (as shown in FIG. 5), the communication logic 212 of the mobile station terminates the call via the transceiver 206 in response to receiving input from the user interface 208 at step 514. The mobile station 106 then transmits a release signal to the MSC/HLR 102, 110 at step 516. Next, the MSC/HLR 102, 110 determines that the call has been terminated and the allocated network resource has been or will be released and, in response, the MSC returns a release acknowledgment to the mobile station 106 at step 518. The mobile station 106, in response to receiving the release acknowledgment, transmits a release network resource signal to the shared access controller 104 at step 520. Thereafter, the shared access controller 104 returns a release network resource acknowledgment to the mobile station 106 at step 522.

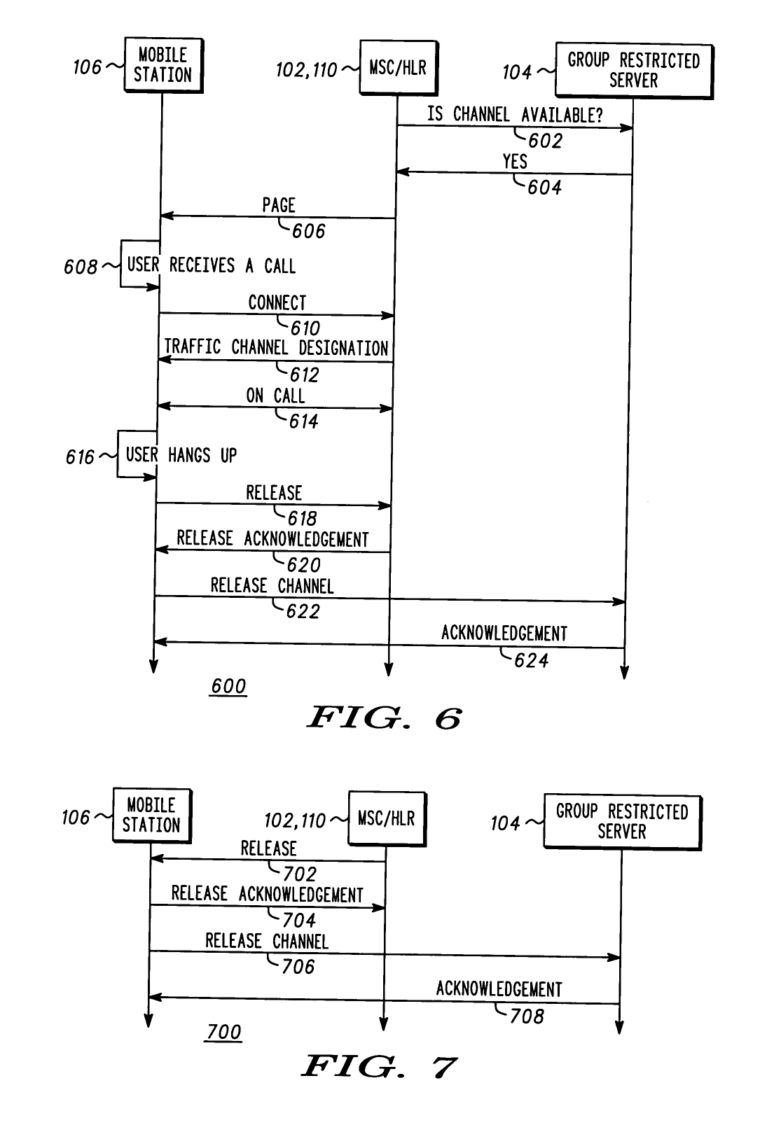

Referring to FIG. 6, there is provided a message sequence chart representing a preferred procedure 600 for a mobile terminated call. For the mobile terminated call, the call is originated by a remote device and is connected to the mobile station 106 through the network infrastructure, including the MSC/HLR 102, 110. In particular, MSC/HLR 102, 110 transmits a network resource request, e.g., a channel request, to the shared access controller 104 at step 602. The shared access controller 104 performs various several steps before returning a response to the network resource request to the MSC/HLR 102, 110 at step 604. If the response indicates that a channel is not available, then the call is not connected. If, on the other hand, the response indicates that a channel is available (as represented by FIG. 6), then the MSC/HLR 102, 110 sends a call signal, such as a page, to the mobile station 106 at step 606. In response to receiving the call signal, the user interface 208 of the mobile station 106 provides a call indication to its user and awaits a call recognition from the user at step 608. If the call is not recognized by the user, then the call is not connected. If, however, the user interface 208 receives the call recognition from the user (as shown in FIG. 6), then the mobile station 106 transmits a connect signal to the MSC/HLR 102, 110 at step 610. Next, the MSC/HLR 102, 110 allocates a traffic network resource to the mobile station 106 and returns a traffic network resource designation signal identifying the traffic network resource to the mobile station at step 612. Thereafter, the call is completed and the mobile station 106 communicates with a remote device via the MSC/HLR 102, 110 at step 614.

A call may be terminated by the mobile station 106 and/or the remote device communicating with the mobile station. For the situation where the mobile station 106 terminates the call (as shown in FIG. 6), the communication logic 212 of the mobile station terminates the call via the transceiver 206 in response to receiving input from the user interface 208 at step 616. The mobile station 106 then transmits a release signal to the MSC/HLR 102, 110 at step 618. Next, the MSC/HLR 102, 110 determines that the call has been terminated and the allocated network resource has been or will be released and, in response, the MSC returns a release acknowledgment to the mobile station 106 at step 620. The mobile station 106, in response to receiving the release acknowledgment, transmits a release network resource signal to the shared access controller 104 at step 622. Thereafter, the shared access controller 104 returns a release network resource acknowledgment to the mobile station 106 at step 624.

Referring to FIG. 7, there is provided a message sequence chart representing a preferred procedure 700 for a peer released call. As stated above, a call may be terminated by the mobile station 106 and/or the remote device communicating with the mobile station. The preferred procedure 700 of the peer released call applies to situations where a call is terminated by the remote device communicating with the mobile station 106, regardless of whether the call is mobile originated or mobile terminated. Accordingly, the steps of FIG. 7 may replace steps 516 through steps 522 of FIG. 5 or steps 618 through 624 of FIG. 6.

In particular, the mobile station 106 receives a release signal from the MSC/HLR 102, 110 at step 702. The call is terminated by the remote device and will be disconnected from the mobile station 106 through the network infrastructure, including the MSC/HLR 102, 110. Next, the mobile station 106 understands that the call has been terminated and the allocated network resource has been or will be released and, in response, the mobile station returns a release acknowledgment to the MSC/HLR 102, 110 at step 704. The mobile station 106, after transmitting the release acknowledgment to the MSC/HLR 102, 110, transmits a release network resource signal to the shared access controller 104 at step 706. In the alternative, the mobile station 106 may transmit the release acknowledgment to the MSC/HLR 102, 110 and the release network resource signal to the shared access controller 104 simultaneously. Thereafter, the shared access controller 104 returns a release network resource acknowledgment to the mobile station 106 at step 708.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A shared access controller for providing restricted access of network resources to mobile stations comprising:
an interface configured to receive a request for access to any available network resource from a mobile station of a tier; and
a processor, coupled to the interface, configured to reject the request in response to determining that a current number of network resources accessed by the mobile stations of the tier would exceed a tier number of network resources permitted to be accessed by mobile stations of the tier.

2. The shared access controller of claim 1, wherein the processor is configured to accept the request for access in response to determining that the current number of network resources is less than the tier number of network resources.

3. The shared access controller of claim 1, wherein the request for access to any available network resource is rejected even though at least one available network resource has been previously allocated to the mobile station of the tier.

4. The shared access controller of claim 1, wherein a total number of network resources is greater than the tier number of network resources.

5. The shared access controller of claim 1, further comprising a memory including tier definitions associating a tier identification with tier maximum number of network resources, channel access counters associating the tier identification with current number of network resources, and a subscriber database associating a subscriber identification with the tier identification.

6. A method for providing restricted access of network resources to mobile stations, the method comprising:
receiving, from a mobile station of a tier, a request for access to any available network resource;
determining whether a current number of network resources accessed by the mobile stations of the tier would exceed a tier number of network resources permitted to be accessed by mobile stations of the tier; and
rejecting the request for access in response to determining that the current number of network resources would exceed the tier number of network resources.

7. The method of claim 6, further comprising accepting the request for access in response to determining that the current number of network resources is less than the tier number of network resources.

8. The method of claim 6, further comprising identifying at least one network resource that is available.

9. The method of claim 8, further comprising allocating the at least one network resource to the mobile station of the tier in response to a previous request for access to any available network resource.

10. The method of claim 6, further comprising allocating a particular network resource, after rejecting access to the particular network resource by the mobile station of the tier, to a different mobile station of a different tier.

11. A mobile station for receiving restricted access of network resources of a wireless communication system, the mobile station comprising:
a transceiver configured to transmit a request for access to any available network resource and to receive a response to the request based on whether a current number of network resources accessed by the mobile stations of the tier would exceed a tier number of network resources permitted to be accessed by mobile stations of the tier.

12. The mobile station of claim 11, wherein the response indicates that the request is rejected because the current number of network resources would exceed the tier number of network resources.

13. The mobile station of claim 11, wherein the response indicates that the request is accepted because the current number of network resources is less than the tier number of network resources.

14. The mobile station of claim 11, wherein a total number of network resources is greater than the tier number of network resources.

15. The mobile station of claim 11, wherein the network resource is a communication channel.

16. A method for receiving restricted access of network resources of a wireless communication system, the method comprising:
transmitting a request for access to any available network resource; and
receiving a response to the request based on whether a current number of network resources accessed by the mobile stations of the tier would exceed a tier number of network resources permitted to be accessed by mobile stations of the tier.

17. The method of claim 16, wherein receiving a response to the request includes receiving the response which indicates that the request is rejected because the current number of network resources would exceed the tier number of network resources.

18. The method of claim 16, wherein receiving a response to the request includes receiving the response which indicates that the request is accepted because the current number of network resources is less than the tier number of network resources.

19. The method of claim 16, further comprising initiating a call before transmitting a request for access to any available network resource.

20. A wireless communication system for providing restricted access of network resources to certain mobile stations comprising:
a first group of mobile stations being capable of accessing a plurality of network resources; and
a second group of mobile stations being capable of accessing the plurality of network resources only if, at any given time, a current number of network resources accessed by the second group of mobile stations does not exceed a tier number of network resources permitted to be accessed by the second group of mobile stations.
